(19) United States
(12) Patent Application Publication
(10) Pub. No.: US 2007/0190873 A1
(43) Pub. Date: Aug. 16, 2007

(54) Care composition

(76) Inventors: Stephen Norman Batchelor, Bebington (GB); Joachim Lienke, Vlaardingen (NL); Matthew Lloyd Parry, Bebington (GB); Johann Bernhard Warnaar, Vlaardingen (NL)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(21) Appl. No.: 11/631,800

(22) PCT Filed: May 13, 2005
(86) PCT No.: PCT/EP05/05388

§ 371 Date: Jan. 5, 2007

(30) Foreign Application Priority Data
Jul. 6, 2004 (GB) 0415129.6

(51) Int. Cl. B32B 5/02; B32B 27/04

(52) U.S. Cl. 442/59; 442/102

(57) ABSTRACT

A method is provided for preserving the integrity of stretchy polymer fibres.

### FIELD OF INVENTION

This invention relates to the treatment of cured polymers that are used in textiles.

### BACKGROUND OF INVENTION

The use of polymer fibers in clothing is ubiquitous. The use of polybutadiene binders in the clothing industry is widespread to permit the printing of images on clothing. The use of natural rubber (a natural polymer) is also found in the waistband of many garments.

Elastane is a commonly used man-made fibre that is used on its own or in mixture with natural fibres for the manufacture of clothing. Elastane fibres, better known under their trade names, Lycra and Dorlastan, are widely commercially available. Elastane was invented in 1937 in Germany and has properties not found in nature, the most important being an extraordinary elasticity. The majority of contour fitting swimming costumes contain elastane.

Elastane fibres can be stretched from four to seven times their length, reverting to their original length when the tension is relaxed. Elastane has the highest stretch tension of all textile raw materials. Two percent elastane is enough to make trousers, for instance, retain their shape. For body-shaped silhouette and high stretch capacity, i.e. in swimwear, corsetry or sportswear, 15 to 40% elastane is used. Elastane fibres provide a high degree of comfort combined with great freedom of movement. In woven and knitted fabrics elastane increases shape retention and accelerates crease recovery.

The aforementioned polymers are also susceptible to degradation. One apparent aspect to their degradation of these polymer containing garments is that that when failure occurs it occurs over a relatively short period of time in the garments lifetime. Another example of failure is where the print binder degrades such that flaking and cracking of the print occurs of because of degradation of the binder.

Aggravating factors that contribute to the loss of integrity of these polymers are, for example, hypochlorites, ozone, sunlight (ultraviolet light), singlet and triplet oxygen.

The fact that many swimming pools contain hypochlorite results in the diminished lifetime of many a swimming costume. The loss of integrity of the elastane in swimming costumes often results in unwanted wobbling and drooping of wobbly bits.

### SUMMARY OF INVENTION

The present invention concerns a method of treating polymers. The present invention has particular utility in treating polymers which are elastomeric. In this regard, an elastomer is defined as a polymer that is capable of being stretched to at least twice its original rest length whilst remaining within its elastic limit, i.e., without undergoing plastic deformation.

The present invention provides use of a composition for increasing the integrity lifetime of an apolar cured elastomeric polymer substrate, the use by applying to the apolar cured elastomeric polymer substrate an antioxidant in an aqueous medium, wherein the apolar substrate forms part or whole of a textile garment (an article of clothing).

By providing a method of treating a garment that consists of or comprises a stretchy polymer the user may choose to treat the garment repeatedly during its lifetime thereby maintaining the garment. This provides an advantage over mere treatment of the polymer before manufacture into a garment. In addition, the present method inhibits the yellowing of the polymer substrates.

The present invention also extends to a commercial package together with instructions for its use.

### DETAILED DESCRIPTION OF THE INVENTION

Antioxidant

The level of the antioxidant in an aqueous solution is 0.01 to 1000 ppm, preferably 0.1 to 100 ppm, most preferably 0.1 to 50 ppm. This level is achieved by dosing an aqueous medium with a composition comprising the antioxidant such that a unit dose provides the desired level in the aqueous medium.

Anti-oxidants are substances as described in Kirk-Othmers (Vol 3, pg 424) and in Uhlmans Encyclopedia (Vol 3, pg 91) and CRC Press Oxidation Inhibition in Organic Materials Vols I and II, Eds. Jan Pospisil and Peter P. Klemchuk: ISBN 0-8493-4767-X and 0-8493-4768-8.

log P is the octanol/water partition coefficient and can be used to measure the hydrphobicity of a molecule. The C Log P values were calculated using daylight software (PCModels version 4.8) available from Daylight Chemical Information Systems, Inc. Sheraton House—Castle Park—Cambridge, UK CB3 0AX.

One class of anti-oxidants suitable for use in the present invention is alkylated phenols having the general formula: 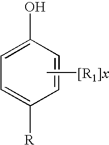
wherein R is C1-C22 linear or branched alkyl, preferably methyl or branched C3-C6 alkyl; C3-C6 alkoxy, preferably methoxy; R1 is a C3-C6 branched alkyl, preferably tert-butyl; x is 1 or 2. Hindered phenolic compounds are preferred as antioxidant.

Another class of anti-oxidants suitable for use in the present invention is a benzofuran or benzopyran derivative having the formula: 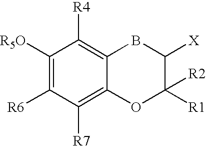
wherein R1 and R2 are each independently alkyl or R1 and R2 can be taken together to form a C5-C6 cyclic hydrocarbyl moiety; B is absent or CH2; R4 is C1-C6 alkyl; R5 is hydrogen or —C(O)R3 wherein R3 is hydrogen or C1-C19 alkyl; R6 is C1-C6 alkyl; R7 is hydrogen or C1-C6 alkyl; X is —CH2OH, or —CH2A wherein A is a nitrogen comprising unit, phenyl, or substituted phenyl. Preferred nitrogen comprising A units include amino, pyrrolidino, piperidino, morpholino, piperazino, and mixtures thereof.

Other suitable antioxidants are found as follows. A derivative of α-tocopherol, beta-tocopherol, gamma-tocopherol, delta-tocopherol, and alkyl esters of gallic acid, especially octyl gallate and dodecyl gallate.

Another example of suitable antioxidants are the class of hindered amine light stabilisers (HALS), particularly those based 2,2,6,6-tetramethylpipiridines.

Non-limiting examples of anti-oxidants suitable for use in the present invention include phenols inter alia 2,6-di-tert-butylphenol, 2,6-di-tert-butyl-4-methylphenol, mixtures of 2 and 3-tert-butyl-4-methoxyphenol.

The presence of an alkyl chain(s) substituent on the antioxidant serves to control the C log P and bring it into the required range.

Mixtures of antioxidants may be use and in particular mixtures that have synergic antioxidant effects as found in, for example, WO02/072746.

Hydroperoxide Decomposing Antioxidants

Hydroperoxide Decomposing Antioxidants (HADs) are compounds that cause the degradation of hydroperoxides. Examples of HADs are found in the organic compounds of sulpher and trivalent phosphorous which are commercialised for stabilising compositions and are widely used in combination with phenolic antioxidants. Zinc Dialkyl Dithio phosphate (ZDDP) is an example of a HAD that is used widely in the automotive oil industry. Generally phosphites decompose hydroperoxides at substantially lower temperatures than sulphides. Triphenylphosphine, a HAD, is a widely recognised reductant for hydroperoxides and functions well at ambient temperatures. Hindered amine light stabilisers (HALS) also function as HADs and is an example of a class of preferred HADs for use with the present invention. A review of HADs are found in: J. Pospísil, P. P. Klemchuk (Eds) Oxidation inhibition in organic materials, Vol. I. CRC Press 1990, pp. 38 to 47. It is preferred that the bleaching composition of the present invention comprises one or more HADs, in particular triphenylphosphine, and most preferably in conjunction with a non-HAD antioxidant.

The Sunscreen

The use of a sunscreen is applicable to the reduction in incident radiation from the sun and incandescent light. The sunscreen serves to further protect to polymer. The sunscreens used herein are photostable.

Protection against solar radiation can be achieved with UVA and UVB absorbing materials with high extinction coefficients. These compounds are commonly called sunscreens. However, the use of such materials is preferably limited for protection against UV radiation with a wavelength of 400 nm or below as compounds with the whole or part of their spectra above 400 nm will be coloured.

It is preferred that the sunscreen has a C log P value in the range from 1.5 to 8.5.

It is preferred that the sunscreen or sunscreen mixture is present at levels in the aqueous solution in the range from 0.01 to 1000 ppm, preferably 0.1 to 100 ppm, most preferably 0.1 to 50 ppm. This level is achieved by dosing an aqueous medium with a composition comprising the sunscreen such that a unit dose provides the desired level in the aqueous medium.

In the context of this invention a sunscreen is described as any material which absorbs UVA or UVB radiation. It is preferred that the sunscreens have a molar extinction coefficient (ε) of greater than 2000 mol⁻¹ cm⁻¹ at 300 nm, most preferably 5000 mol⁻¹ cm⁻¹ at 300 nm. Further it is preferred that the extinction coefficient of the sunscreen is less than 100 mol⁻¹ cm⁻¹ at any single wavelength in the range from 400 nm at 750 nm.

The International Commission on Illumination (CIE) in 1970 defined the UV wavelength subdivisions as:

| | |
|---|---|
| UVA | 315-400 nm |
| UVB | 280-315 nm |
| UVC | 100-280 nm |

Preferably the sunscreen absorbs light at a wavelength from about 280-400 nm.

Suitable sunscreens are described in: CRC Press Oxidation Inhibition in Organic Materials Vols I and II, Eds. Jan Pospisil and Peter P. Klemchuk: ISBN 0-8493-4767-X and 0-8493-4768 and Sunscreens: Development, Evaluation, and Regulatory Aspects Second Edition edited by Nicholas J. Lowe, Nadim A. Shaath and Madhu A. Pathak ISBN: 0824793064.

Typical examples of sunscreens that may be employed in the present invention are: cinnamates, hydroxybenzophenones, alpha-cyanoacrylates, oxanilides, phenylsalicylates, and 2-hydroxyphenylbenzotriazoles.

Examples of typical sunscreens but not meant to be exclusive are: UVA absorbers
Oxybenzone
Suisobenzone
Dioxybenzone
tinuvin 329
tinuvin 327
tinuvin 328
   UVB Absorbers
aminobenzoic acid
amyldimethyl (PABA)
2-Ethoxyethyl-p-methoxycinnimate
amyldimethyl PABA (padimate A)
2-Ethylhexyl salicylate (Sunarome WMO)
Ethyl 4-bis(hydroxypropyl)aminiobenzoate
2-Ethylhexyl-2-cyano-3,3-diphenylacrylate
Ethylhexyl-p-methoxcinnate
2-Ethylhexyl salicylate (Sunarome WMO)
Glyceryl aminobenzoate (Glyceryl PABA)
Homomenthyl salicylate
Lawsone with dihydroxyacetate
Octyldimethyl PABA (Padimate O)
2-Phenylbenzimidazole-5-sulphonic acid
Thethanolamine salicylate
Cyasorb UV 2908
Cyasorb UV 24
Chimassorb 81
   Balance Carriers and Adjunct Ingredients

These may be surfactants, builders, foam agents, anti-foam agents, solvents, and enzymes. The use and amounts of these components are such that the bleaching composition performs depending upon economics, environmental factors and use of the bleaching composition.

The composition may comprise a surfactant and optionally other conventional detergent ingredients. The composition may also comprise an enzymatic detergent composition which comprises from 0.1-50% by weight, based on the total detergent composition, of one or more surfactants. This surfactant system may in turn comprise 0-95% by weight of one or more anionic surfactants and 5 to 100% by weight of one or more nonionic surfactants. The surfactant system may additionally contain amphoteric or zwitterionic detergent compounds, but this in not normally desired owing to their relatively high cost. The enzymatic detergent composition according to the invention will generally be used as a dilution in water of about 0.05 to 2%.

It is preferred that the bleaching composition comprises between 2 to 60 wt % of a surfactant. In general, the nonionic and anionic surfactants of the surfactant system may be chosen from the surfactants described “Surface Active Agents” Vol. 1, by Schwartz & Perry, Interscience 1949, Vol. 2 by Schwartz, Perry & Berch, Interscience 1958, in the current edition of “McCutcheon's Emulsifiers and Detergents” published by Manufacturing Confectioners Company or in “Tenside-Taschenbuch”, H. Stache, 2nd Edn., Carl Hauser Verlag, 1981.

Suitable nonionic detergent compounds which may be used include, in particular, the reaction products of compounds having a hydrophobic group and a reactive hydrogen atom, for example, aliphatic alcohols, acids, amides or alkyl phenols with alkylene oxides, especially ethylene oxide either alone or with propylene oxide. Specific nonionic detergent compounds are C₆-C₂₂ alkyl phenol-ethylene oxide condensates, generally 5 to 25 EO, i.e. 5 to 25 units of ethylene oxide per molecule, and the condensation products of aliphatic C₈-C₁₈ primary or secondary linear or branched alcohols with ethylene oxide, generally 5 to 40 EO.

Suitable anionic detergent compounds which may be used are usually water-soluble alkali metal salts of organic sulphates and sulphonates having alkyl radicals containing from about 8 to about 22 carbon atoms, the term alkyl being used to include the alkyl portion of higher acyl radicals. Examples of suitable synthetic anionic detergent compounds are sodium and potassium alkyl sulphates, especially those obtained by sulphating higher C₈-C₁₈ alcohols, produced for example from tallow or coconut oil, sodium and potassium alkyl C₉-C₂₀ benzene sulphonates, particularly sodium linear secondary alkyl C₁₀-C₁₅ benzene sulphonates; and sodium alkyl glyceryl ether sulphates, especially those ethers of the higher alcohols derived from tallow or coconut oil and synthetic alcohols derived from petroleum. The preferred anionic detergent compounds are sodium C₁₁-C₁₅ alkyl benzene sulphonates and sodium C₁₂-C₁₈ alkyl sulphates. Also applicable are surfactants such as those described in EP-A-328 177 (Unilever), which show resistance to salting-out, the alkyl polyglycoside surfactants described in EP-A-070 074, and alkyl monoglycosides.

Preferred surfactant systems are mixtures of anionic with nonionic detergent active materials, in particular the groups and examples of anionic and nonionic surfactants pointed out in EP-A-346 995 (Unilever). Especially preferred is surfactant system that is a mixture of an alkali metal salt of a C₁₆-C₁₈ primary alcohol sulphate together with a C₁₂-C₁₅ primary alcohol 3-7 EO ethoxylate.

The nonionic detergent is preferably present in amounts greater than 10%, e.g. 25-90% by weight of the surfactant system. Anionic surfactants can be present for example in amounts in the range from about 5% to about 40% by weight of the surfactant system.

Cationic Compound

When the present invention is used as a fabric conditioner it needs to contain a cationic compound.

Most preferred are quaternary ammonium compounds.

It is advantageous if the quaternary ammonium compound is a quaternary ammonium compound having at least one C₁₂-C₂₂ alkyl chain.

It is preferred if the quaternary ammonium compound has the following formula: 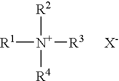
in which R¹ is a C₁₂ to C₂₂ alkyl or alkenyl chain; R², R³ and R⁴ are independently selected from C₁-C₄ alkyl chains and X⁻ is a compatible anion. A preferred compound of this type is the quaternary ammonium compound cetyl trimethyl quaternary ammonium bromide.

A second class of materials for use with the present invention are the quaternary ammonium compound having the following formula: 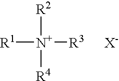
in which R¹ and R² are indepently selected from C₁₂ to C₂₂ alkyl or alkenyl chain; R³ and R⁴ are independently selected from C₁-C₄ alkyl chains and X⁻ is a compatible anion.

A detergent composition according to claim 1 in which the ratio of (ii) cationic material to (iv) anionic surfactant is at least 2:1.

Other suitable quatenary ammonium compounds are disclosed in EP 0 239 910 (Procer and Gamble).

It is preferred if the ratio of cationic to nonionic surfactant is from 1:100 to 50:50, more preferably 1:50 to 20:50.

The cationic compound may be present from 0.02 wt % to 20 wt % of the total weight of the composition.

Preferably the cationic compound may be present from 0.05 wt % to 15 wt %, a more preferred composition range is from 0.2 wt % to 5 wt %, and most preferably the composition range is from 0.4 wt % to 2.5 wt % of the total weight of the composition.

If the product is a liquid it is preferred if the level of cationic surfactant is from 0.05 wt % to 10 wt % of the total weight of the composition. Preferably the cationic compound may be present from 0.2 wt % to 5 wt %, and most preferably from 0.4 wt % to 2.5 wt % of the total weight of the composition.

If the product is a solid it is preferred if the level of cationic surfactant is 0.05 wt % to 15 wt % of the total weight of the composition. A more preferred composition range is from 0.2 wt % to 10 wt %, and the most preferred composition range is from 0.9 wt % to 3.0 wt % of the total weight of the composition.

### EXPERIMENTAL

Antioxidants were initially dissolved in an ethanol solution in order to air their disolution in the aqueous medium. A stock wash solution was prepared using sodium dodecyl sulphate (SDS), pH 10 buffer, demin water.

UV-Visible spectra of the wash solution was recorded. Aliquots of each ethanol solution were added to individual portions of the wash solution drop wise with stirring to maintain dissolution of the antioxidants.

UV-Visible spectra of the resulting mixtures were recorded. Pieces of test cloth (100% elastane) were added to the wash solutions containing the antioxidants and were agitated for 30 mins. UV-Visable spectra of the final mixtures were recorded and the amount of antioxidant/sunscreen determined.

Compositions

Ethanol/Antioxidant Solutions

Each selected antioxidant (0.12g) was dissolved in ethanol to a total volume of 50 ml.

Wash Solution

SDS (sodium dodecyl sulphate) was selected as the surfactant because it does not absorb in the UV Visible region of the spectrum. To mimic a 2 g/l formulation, 0.8 g SDS (20% of formulation being surfactant) was added to a 2 l volumetric flask and made up to 2 l with demin water and pH 10 carbonate buffer (at similar level to SDS).

Wash Solution Containing Antioxidant

25:1 Liquor to cloth ratio chosen for the wash experiments 12.5 g of wash solution added to a 120 ml glass bottle 200 ul of ethanol/antioxidant solution added to the wash solution to generate a 20 ppm solution with respect to the antioxidant.

| | | % Deposited |
|---|---|---|
| | | from |
| Antioxidant | C Log P | solution |
| Ferulic acid | 1.42 | 11.56 |
| Propyl gallate | 1.99 | 4.86 |
| Cyasorb UV 24 | 3.49 | 88.27 |
| Anthrancine DG, (Dodecyl gallate) | 5.69 | 79.73 |
| 2-Ethylhexyl salicylate | 5.91 | 83.48 |
| 2-ethylhexyltrans-4-methoxycinnamate | 5.96 | 95.08 |
| 2-Ethylhexyl 4-(dimethylamino)benzoate | 6.16 | 95.81 |
| 2-Ethylhexyl 2-cyano-3,3-diphenylacrylate | 6.8 | 94.35 |
| Chimassorb 81 | 7.29 | 89.87 |
| tinuvin 329 | 7.63 | 94.75 |
| tinuvin 327 | 8.35 | 2.53 |
| tinuvin 328 | 8.56 | −0.58 |
| Cyasorb UV 2908 | 13.37 | −1.96 |
| Irgafos TTNP | 19.92 | 0.24 |

| Antioxidant | | CAS No |
|---|---|---|
| Ferulic acid | 3-Methoxy-4-hydroxy-trans- | 537-98-4 |
| | cinnamate | |
| Cyasorb UV 24 | 2,2′-Dihydroxy-4- | 131-53-3 |
| | methoxybenzophenone | |
| Chimassorb 81 | Methanone,[2-hydroxy-4- | 1843-05-6 |
| | (octyloxy)phenyl]phenyl- | |
| tinuvin 329 | 2-(2H-benzotriazol-2-yl)-4- | 3147-75-9 |
| | (tert-butyl)-6-(sec-butyl)phenol | |
| tinuvin 327 | 2,4-di-tert-butyl-6-(5- | 3864-99-1 |
| | chlorobenzotriazol-2-yl)phenol | |
| tinuvin 328 | 2-(2H-benzotriazol-2-yl)-4,6- | 25973-55-1 |
| | di-tertpentylphenol | |
| Cyasorb UV 2908 | 3,5-di-t-butyl-4-hydroxybenzoic | 67845-93-6 |
| | acid, Hexadecyl Ester | |
| Irgafos TTNP | Tris-nonylphenyl phosphite | 26523-78-4 |

### Integrity Experiment 1

A 1.8 g piece of 25% elastane and 75% nylon fabric was washed in 180 ml water at 293K, containing 0.4 g/L SDS surfactant and buffered to pH 10 using a carbonate buffer. The cloth was then rinsed 3 times in demineralised water and dried. Following this the elastane part of the fabric was dissolved by immersing the fabric in di-methyl acetamide and the molecular weight of the polymer determined by Gel Phase Chromatography. This procedure was repeated but with repeat washes. The results are shown in the table below in which the values given are the average of 2 repeat experiments.

| No. of washes | Mn | PD |
|---|---|---|
| 1 | 37500 | 1.97 |
| 2 | 36200 | 1.93 |
| 3 | 34500 | 1.85 |
| 4 | 29800 | 1.97 |
| 5 | 30800 | 2.07 |

Mn = number averaged molecular number
PD = poly dispersity

As the number of washes increases, Mn slowly decreases indicating gradual damage to the polymer.

### Integrity Experiment 2

The experiment of integrity experiment 1 was repeated except after each wash the cloth was irradiated for 7.2 hours in a weathermeter set to mimic 385 W/m² of outside sunlight. The results are given in the table below in which the values given are the average of 2 repeat experiments.

| No. of washes | Mn | PD |
|---|---|---|
| 1 | 32500 | 2.32 |
| 2 | 30200 | 2.63 |
| 3 | 20300 | 4.00 |
| 4 | 14600 | 4.93 |
| 5 | 7030 | 8.91 |

As the number of wash/irradiation cycles increases the Mn decreases and PD increases, indicating strong damage to the fiber by the sunlight exposure.

### Integrity Experiment 3

Integrity Experiment 2 was repeated except 20 ppm of protection agent was added to each wash and the Chromatography only performed after 5 wash/irradiate cycles. The results are given in the Table below in which the values given are the average of 2 repeat experiments.

| Protection agent | Mn | PD |
|---|---|---|
| None | 7030 | 8.91 |
| Tinuvin 329 | 13600 | 4.94 |
| Tinuvin 770 | 17800 | 5.41 |
| Dodecyl gallate | 23200 | 4.46 |

Tinuvin 770 [bis(2,2,6,6-tetramethyl-4-piperidinyl)sebacate] is a HALS antioxidant ex Ciba Speciality chemicals.

The sunscreen and antioxidants all reduce the damage to the polymer induced by the sunlight exposure. This is shown by a higher Mn and lower PD compared to control.

1. Use of a composition for increasing the integrity lifetime of an apolar cured elastomeric polymer substrate, the use by applying to the apolar cured elastomeric polymer substrate an antioxidant in an aqueous medium, wherein the apolar substrate forms part or whole of a textile garment.

2. Use according to claim 1, wherein the antioxidant is present in the aqueous solution in the range from 0.01 to 1000 ppm.

3. Use according to claim 1, wherein the antioxidant is selected from:
(i) a phenolic antioxidant; and,
(ii) a hindered amine antioxidant.

4. Use according to claim 3, wherein the antioxidant is a hindered phenol.

5. Use according to claim 3, wherein the antioxidant is selected from the group consisting of: 2,6-di-tert-butyl hydroxyl toluene, octylgallate, and dodecylgallate.

6. Use according to claim 1, wherein the aqueous medium comprises a photostable organic sunscreen having a C log P value of at least 1.9 and having an extinction coefficient of greater than 2000 mol⁻¹ cm⁻¹ at 300 nm and an extinction coefficient of less than 100 mol⁻¹ cm⁻¹ at any single wavelength in the range from 400 nm at 750 nm.

7. Use according to claim 1, wherein the apolar cured polymer substrate is an elastomeric synthetic apolar cured polymer substrate.

8. Use according to claim 1, wherein the antioxidant has a C log P value in the range from 1.5 to 8.5.

9. Use according to claim 1 comprising the step of drying the garment after application.

10. Use according to claim 1, wherein the aqueous medium comprises a fabric conditioner.

11. Use according to claim 1, wherein the an aqueous medium is without a surfactant.

12. Use according to claim 1, wherein the an aqueous medium comprises a surfactant.

13. Use according to claim 1, wherein an apolar cured polymer is selected from the group consisting of: polybutadiene binder, elastane, and latex.
